(19) United States
(12) Patent Application Publication
(10) Pub. No.: US 2007/0280138 A1
(43) Pub. Date: Dec. 6, 2007

(54) INFORMATION BROADCASTING SYSTEM AND METHOD

(76) Inventor: Donald S. Stern, Lexington, KY (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/754,188

(22) Filed: May 25, 2007

Related U.S. Application Data
(60) Provisional application No. 60/809,983, filed on Jun. 1, 2006.

(51) Int. Cl. H04L 12/28; H04Q 7/00

(52) U.S. Cl. 370/254; 370/329

(57) ABSTRACT

Embodiments for a system and method of broadcasting messages to communication devices in a mobile communication network are described. The method includes registering at least one communication device configured to receive broadcast messages serviced by a base station, allocating at least one registered communication device as a primary communication device for the base station and the remaining registered communication devices as secondary communication devices, and providing information identifying the primary communication device to each secondary communication device. The method further includes allocating a channel for transmitting a multicast message to the primary communication device, providing information identifying the allocated channel to the primary and secondary communication devices, and transmitting broadcast data over the allocated channel.

### CROSS-REFERENCE TO RELATED APPLICATIONS

This application claims the benefit of U.S. provisional application Ser. No. 60/809,983, entitled “SYSTEM AND METHOD FOR MULTICASTING INFORMATION TO ONE OR MORE COMPUTING DEVICES”, filed on Jun. 1, 2006 which is incorporated by reference in its entirety.

### BACKGROUND OF THE INVENTION

1. Field of the Invention

The technical field of the present invention is multicasting information. An example of an application of the invention is broadcasting information to users' mobile devices during an emergency, such as a natural disaster warning.

2. Description of the Related Art

Various mobile devices are used today to permit people to communicate with each other. These mobile devices support many different one-to-one communications protocols, such as voice, short text messages (SMS), multimedia messages (MMS) and client/server browsing and email protocols.

The ability to allow many users (one-to-many) to view or receive a single message is supported in the Internet TCP/IP protocol for viewing streaming content but mobile devices currently do not support a shared messaging system. New 3G GSM systems are being put in place that do permit shared messaging, but require that all of the existing mobile devices be replaced with new 3G communications computing devices. It is desirable to have a system and method that permits existing mobile devices to receive and display one-to-many message and other formatted content.

### SUMMARY OF THE INVENTION

According to one aspect of the invention, there is provided a method of broadcasting messages to communications computing devices in use in a mobile communication network, the method comprising the steps of:

registering at least one communication device serviced by a base station, the at least one communication device configured to receive broadcast messages;

allocating at least one registered communication device as a primary communication device for the base station and the remaining registered communication devices as secondary communication devices; and

providing information identifying the primary communication device to each secondary communication device.

According to another aspect of the invention, there is provided a system for enabling messages to be broadcast to communications computing devices in use in a mobile communication network, the system comprising:

a network interface module configured to communicate with a content unit configured to provide content for broadcast; and

a broadcast management unit configured to connect to a communication network and register identification information for communication devices serviced by one or more base stations, the communication devices configured to receive broadcast messages, and allocate at least one communication device for each of the base stations as a primary communication device for broadcast purposes and allocate other communication devices as secondary communication devices, the broadcast management unit being further configured to deliver the content provided by the content unit to one or more of the primary communication devices using a communication channel allocated by the communication network, whereby the secondary communication devices monitor the channel allocated to the primary communication device.

According to another aspect of the invention, there is provided a shared messaging unit for a communication computing device comprising:

a memory module configured to store information identifying a primary communication device for a base station servicing the communication device; and

a monitoring module configured to monitor channel allocations transmitted by the base station to determine that a channel is allocated to the primary communication device, based at least in part on said stored identifying information.

According to another aspect of the invention, there is provided a method of receiving broadcast messages in a mobile communication network, the method comprising:

registering a communication device to receive broadcast messages;

receiving information allocating the registered communication device as a primary communication device for a base station or a secondary communication device;

receiving information identifying the primary communication device for the base station; and

monitoring for a channel to be allocated to the primary communication device for broadcast purposes.

An embodiment of the above system and method can be used to implement multicast messaging (one to many) using existing communication network technology and communications computing devices. An advantage of the systems is it can be used for a global warning system or sharing corporate news to a defined list of user in real time as a shared experience.

According to another aspect of the invention, there is provided a computer readable medium comprising programming instructions that upon executing cause a machine to register at least one communication device configured to receive broadcast messages serviced by a base station, allocate at least one registered communication device as a primary communication device for the base station and allocate the remaining registered communication devices as secondary communication devices, and provide information identifying the primary communication device to each secondary communication device.

According to another aspect of the invention, there is provided a computer readable medium comprising programming instructions that upon executing cause a machine to register a communication device to receive broadcast messages, receive information allocating the registered communication device as a primary communication device for a base station or a secondary communication device, receive information identifying the primary communication device for the base station, and monitor for a channel to be allocated to the primary communication device for broadcast purposes.

The shared messaging unit of each communication computing device may be implemented as a piece of software executed by the processing unit of the communications computing device. The shared messaging unit enables the communications computing device to monitor one or more multicast channel(s) and receive content over the multicast channel(s).

Embodiments of the invention enable simultaneous receipt of content by a plurality of communications computing devices. The content can be in the form of a message, audio, picture, video stream or many other content formats supported by the communications computing device.

Many different version of this system can be deployed by combining the broadcast or multicast distribution process that is supported in internet routes and wireless services which support broadcast, multicast or streaming data to communications computing device.

Communications computing devices are typically loaded with software that limits the device to only receiving and processing data addressed to the communication computing device and only using a channel allocated to the communication computing device, thus only a one-to-one data interface is supported. However, the hardware of a communications computing device can receive all of the wireless signals and these signals are filtered by the hardware, firmware and software such that only signals directed to the communication computing device are processed.

In one embodiment, by loading shared messaging unit software that enables and supports functions like IP multicast, the communications computing device can join a multicast channel. The multicast channel is a channel allocated to another communication computing device which can be identified as a multicast channel and the shared messaging unit enables the communications computing device to “read only” monitor the data stream on this multicast channel in order to receive and display a one-to-many data stream.

In one embodiment, a communication computing device is configured to watch for particular channel assignments for other selected communication computing devices. If the channel is properly configured for a selected other device the communication computing device is adapted to only read the data being sent to the other device on the channel. By having a single device, a set of devices selected or a special address of a device that does not exist as selected special communication computing devices for broadcast purposes, then other devices can not only watch for their own channel allocation but also for channel allocation to a special device and then read the data being sent to that device and determine whether this data is broadcast data to render for the user.

“Communications computing device” is used throughout the following specification and claims to refer to user devices including but not limited to mobile phones that operate using various communications protocols (for example, such as 2G, 2.5G, 3G, CDMA, TDMA, GPRS, Edge, UTMS and other wireless data protocols), PDAs, wireless email devices, wireless communication devices, such as the RIM Blackberry, wirelessly coupled computer systems (laptops, desktops, etc.), computer systems connected over a wired link, satellite devices that receive data over a satellite link or any device with a processing unit, sufficient memory and connectivity resources that communicate using a one-to-one protocols.

“Broadcast” is used throughout this specification to refer to one directional communication, where a source transmits data to be received one or many parties and no data is transmitted back to the source by the receiving parties.

“Multicast” is used to refer to a one-to-many communication mode. Multicast channel is used throughout this specification to refer to a communication channel allocated such that data transmitted on this channel is allowed to be received by more than one communication computing device.

### BRIEF DESCRIPTION OF THE DRAWINGS

An embodiment, incorporating all aspects of the invention, will now be described by way of example only with reference to the accompanying drawings in which:

FIG. 1 illustrates a multicast network which distributes a one to many content message.

FIG. 2 illustrates an example of an embodiment of a message broadcast system of the invention.

FIG. 3 is an example of a broadcast message reception process according to an embodiment of the invention.

FIG. 4 is a block diagram of a system according to an embodiment of the invention.

FIGS. 5a and 5b illustrate a handover of a broadcast channel.

FIG. 6 is a block diagram of a mobile device adapted to use a broadcast system in an embodiment of the invention.

FIG. 7 is an example of a registration process in an embodiment of the invention.

FIG. 8 is an example of a broadcast transmission process in an embodiment of the invention.

FIG. 9 is an example of a handover process in an embodiment of the invention.

### DETAILED DESCRIPTION OF THE INVENTION

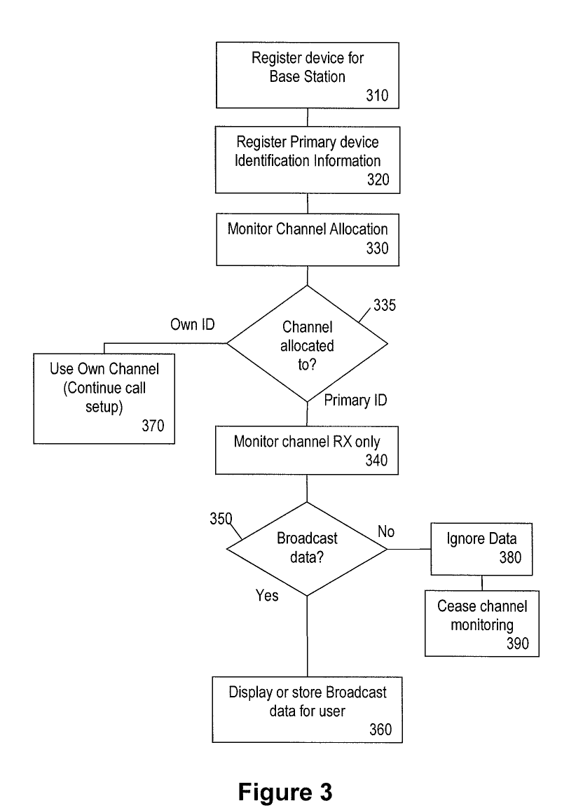

A method of broadcasting messages to communications computing devices in use in a mobile communication network is illustrated in FIG. 3. Each communication computing device has a shared messaging unit. Each of the communication computing devices serviced by each base station is registered 310 for broadcast purposes with a broadcast system. For each base station at least one registered communication computing device is allocated as a primary or master communication computing device for the base station for broadcast purposes and the remaining communication computing devices are registered for the base station as secondary communication devices for broadcast purposes. Identification information for each primary communication computing device for a base station is registered 320 with the shared messaging unit of each secondary communication computing device for the base station.

The shared messaging unit for each secondary communication computing device monitors the channel allocations by the base station 330, and checks identification information for each channel allocation 335, for example as part of the normal monitoring of control channel signals to identify when a call is being made to the communication computing device. If a channel is allocated to the primary communication computing device, the communication computing device monitors the allocated channel 340 and receives any data transmitted on the allocated channel. The shared messaging unit can determine whether the transmitted data is broadcast data 350 which in turn is displayed or stored 360 to make the broadcast data available to the user of the secondary communication computing device.

Where the shared messaging unit determines any received data is not broadcast data 350 the received data is ignored 380 and monitoring of the allocated channel ceases 390.

If a channel is allocated to the communication computing device, for example as part of a call setup process, the communication computing device uses the allocated channel 370 for the appropriate purpose in accordance with its normal operation, for example, to continue the call setup.

Current wireless communication networks, such as GSM networks, always allocate one-to-one communication channels between a base station and a communication computing device. Two-way communication on an allocated channel between the communication computing device and the base station is essential to retain the communication channel allocation. If a base station ceases to receive response or acknowledgement signals from a communication computing device on an allocated channel, the assumption is the communication computing device can no longer communicate with the base station, for example due to being turned off or obstructed, so the allocated channel is released. Multicast, one-to-many, channel allocation is not currently implemented in such communication systems.

Embodiments overcome the limitation of one-to-one channel allocation for multicast broadcast purposes by enabling a plurality of secondary communication computing devices to “listen in” to a one-to-one communication channel allocated to a primary communication computing device such that these secondary devices can also receive data transmitted on this channel, referred to as a multicast channel. The secondary devices are only allowed to receive data transmitted on the multicast channel, whereas the primary device can also transmit on the multicast channel.

By establishing a one-to-one channel with a primary communication computing device, the primary device can respond to base station signals as required to maintain the channel allocation. The secondary devices can receive data transmitted on this multicast channel but are prohibited from transmitting on this channel. Thus, all communication computing devices being serviced by a base station can receive data broadcast on a single channel.

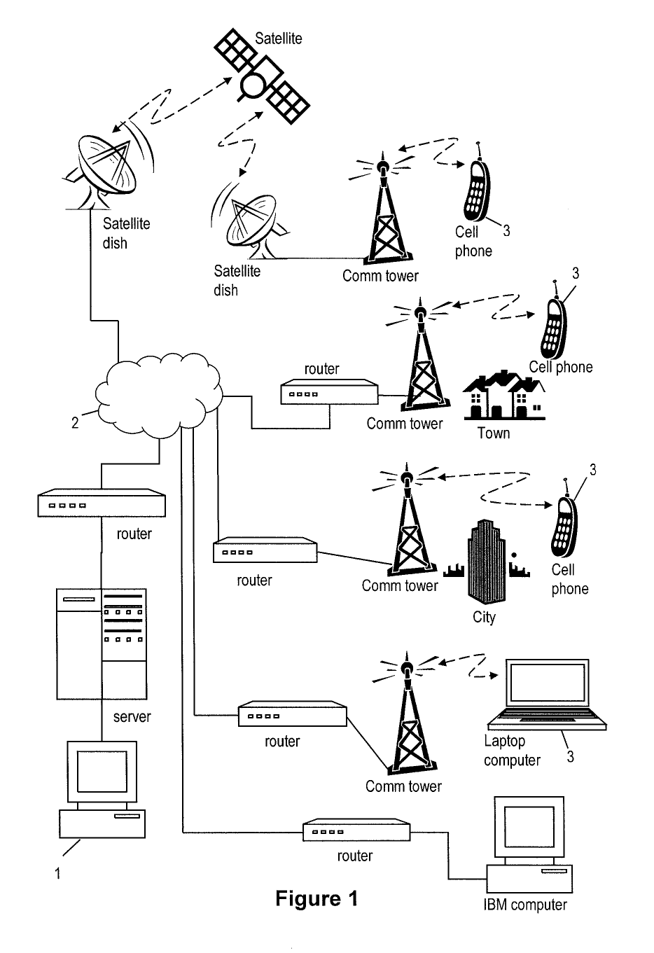

A network is illustrated in FIG. 1, wherein a multicast process according to some embodiments of the invention is used to send content from a content source 1 through a network 2 to one or more communications computing devices 3. Examples of communications computing devices include mobile phones that operate using various communications protocols (for example, such as 2G, 2.5g 3G, CDMA, TDMA, GPRS, EDGE, UTMS), PDAs, WiFi or WiMax networks, wireless email devices, wireless communication devices, such as the RIM Blackberry, wirelessly coupled computer systems (laptops, desktops, etc.), computer systems connected over a wired link, satellite devices that receive data over a satellite link or any device with a processing unit, sufficient memory and connectivity resources that communicate using a one-to-one protocols.

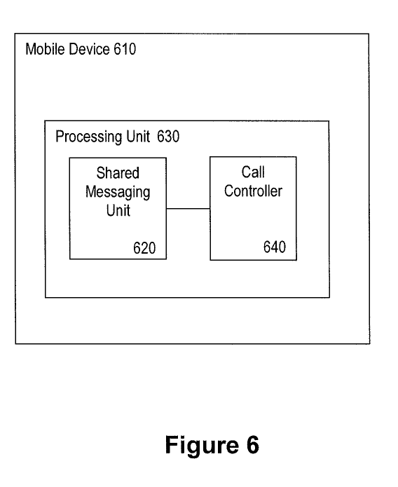

FIG. 6 is a block diagram of a mobile device adapted to use a broadcast system in an embodiment. In one embodiment, each communications computing device 610 includes a shared messaging unit 620, as illustrated in FIG. 6, for receiving broadcast information. The shared messaging unit may be implemented as a piece of software executed by the processing unit 630 of the communications computing device 610. The shared messaging unit allows a secondary communications computing device to monitor one or more multicast channel(s) allocated to one or more primary communication computing device(s) and receive content over the multicast channel(s).

The multicast channels are identified during the channel allocation process by a secondary device by determining that a channel is allocated to a primary communication computing device and that the channel is allocated for broadcast purposes. The shared messaging unit 620 interfaces with the call controller 640 of the communication computing device in order to identify and monitor any multicast channels. In one embodiment of the invention, the shared messaging unit and call control are implemented as functions in the digital signal processing (DSP) unit 630 of the communication computing device 610. This can be done in hardware or software. For example, a channel allocation to a primary communication computing device may be identified from an International Mobile Subscriber Identity (IMSI) or International Mobile Equipment Identity (IMEI) used during channel allocation and setup.

The call controller 640 processes signals received on a control channel. When a channel allocation signal is received, normally the call controller disregards any channel allocation signals for other communication computing devices. However, in some embodiments of the invention, any channel allocation signals for other devices are checked against primary communication computing device information, such as the IMSI, IMEI or phone number, registered with the shared messaging unit, if there is a match for a primary device then this channel, allocated to the primary device, is monitored by the communication computing device. Each secondary device monitors the channel allocation signaling between the primary device and the base station to determine which channel is allocated to the primary device, and then the secondary device monitors “read only” data transmitted on the channel allocated to the primary device. Thus, data transmitted on that channel to the primary communication computing device can also be received by secondary communication devices.

A multicast channel used to broadcast information to the secondary devices as well as the primary device may be distinguished from a channel allocated to the primary device for a private one-to-one communication in any manner able to be interpreted by the shared messaging unit, such that only data broadcast on a multicast channel is delivered to secondary communication computing device users. For example an identifier may be used during channel allocation and setup to indicate a multicast channel or a data packet header for data sent on the channel can be used to identify this as multicast data. The header may also be used to identify which devices are to listen to the multicast data.

Alternatively a different encoding scheme or encryption key, known to the secondary communication devices, may be used for a multicast channel. In this embodiment a different encryption scheme or key is used for broadcast messages than for private one-to-one communication for the primary communication computing device. Thus, the secondary communication computing devices may be inhibited from decrypting any private communication, which also indicates that this is not broadcast data and the secondary device can cease to monitor the channel allocated to the primary device.

An encryption scheme or encryption keys for broadcast data may be pre-programmed in the communication computing devices or communicated during the registration process. For example, encryption scheme information or keys can be transmitted to a communication computing device when it registers for the broadcast service when it is first turned ON. This information may also be updated during a handover, for example as part of updating primary device information where a key is based on the allocated primary device or base station. For example, when a new primary device is allocated the information transmitted to the secondary devices can include encryption key information in addition to the primary device identification information, which is then stored by the secondary devices for subsequent channel monitoring.

A direction to use a multicast encoding scheme or encryption key may be given by the base station or the primary communication computing device during the channel set up process in different embodiments. In another embodiment, broadcast data may be transmitted on the multicast channel without encryption.

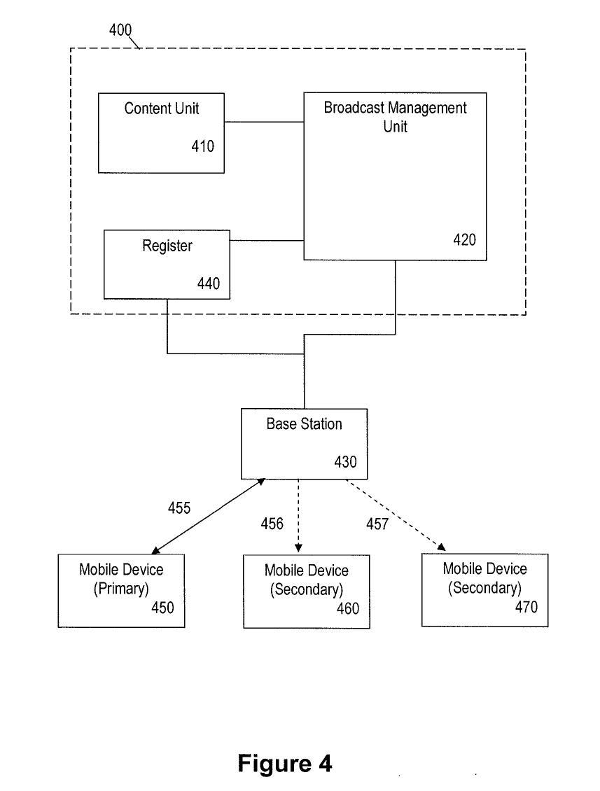

The above paragraphs describe the interface between base stations and communication computing devices in some embodiments of the invention. FIG. 4 is a block diagram of a system according to an embodiment. The embodiment shown in FIG. 4 provides a multicast system 400 for controlling the multicast broadcast and providing the broadcast content data. As illustrated in FIG. 4, the multicast broadcast system 400 of embodiments of the invention includes a broadcast management server 420 and a register 440 in which identification information for the communication computing device, such as an IMSI, IMEI or phone number, and the base station 430 servicing the communication computing device is registered. The register 440 and broadcast management unit 420 may be implemented in software in a single broadcast management server or separate hardware and software components. The multicast system 400 can also include a content unit 410 for providing content data for broadcast. The content unit can be implemented in a broadcast management server or can be a separate secure hardware unit, for example connectable to a broadcast management server, using a direct or remote connection or via the Internet. Alternatively the content unit could connect to the broadcast management server using a private interface or network, e.g., a network interface module.

The broadcast management unit 420 can be connected to the communication network of the base stations 430 servicing the communication computing devices 450, 460 and 470 via the Internet or be implemented as part of the communication network infrastructure, for example as a server co-located with a communication network controller such as a base station controller (BSC), main switch controller (MSC), or as part of the central processor subsystem. Implementing the broadcast management system as part of the communication network may have security advantages over a remotely located system. However, this may also have a disadvantage of the maintenance of the broadcast management system being dependent on the communication network operator or potential lack of network carrier independence for the delivery of broadcast data.

In one embodiment of the invention, the broadcast management unit is implemented in a broadcast server connected via the Internet to a communication network. When a communication computing device registers on the communication network, it can also register or join a broadcast multicast system to receive a stream of data content. The registration with the multicast system can be performed automatically when a communication computing device adapted with a shared messaging unit connects to a base station, for example where the broadcast multicast system is used as an emergency broadcast system.

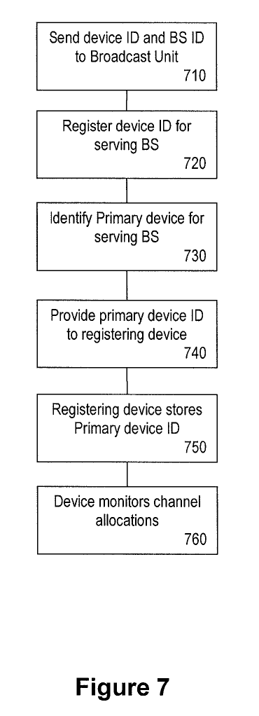

An example of the registration process for the system and network of FIG. 4 is illustrated in FIG. 7. To register with the broadcast system, identification information for the communication computing device and the base station the communication computing device is currently in service with are sent to the broadcast system 710 and the communication computing device registered 720 in the register 440 for the servicing base station 430. The primary communication computing device 450 is identified 730 for the servicing base station 430 from the information in the register 440.

Where no primary communication computing device is registered, such as where the registering communication computing device is the first device to register for the servicing base station, this device may be registered as the primary device for the base station for broadcast purposes.

Where a device is already registered as a primary communication computing device for broadcast purposes for the base station, information for this primary device may be read from the register. The identification information for the primary device is then returned 740 to the registering communication computing device, and stored 750 by the registering communication computing device.

Other information such as an encryption key or multicast identifier can also be returned to the registering communication computing device in step 740 or in an additional step. Once the registration is complete the communication computing device switches into a mode for monitoring channel allocations 760 for allocation of a multicast channel.

In one embodiment, the above registration process is performed after the communication computing device has registered with a base station of the communication network, for example when the communication computing device is switched on or when a communication computing device enters the service area of a base station and concludes a handover from a previous servicing base station. In this embodiment the shared messaging unit is adapted to trigger a connection to be made automatically by the communication computing device to connect to the broadcast management server, for example using a GPRS communication session to a known broadcast server address stored in shared messaging unit or device memory. The device identification and servicing base station information can then be sent directly to the broadcast server by the device and the primary device information returned. Once the registration process is complete this communication session is closed and the device enters a channel allocation monitoring mode. The registration may be adapted to be performed automatically when a communication computing device is turned ON or only after requested by a device user.

Where the registration with the broadcast multicast system is turned ON or OFF by the user, the shared messaging unit may still be adapted to perform an automatic registration on base station handover to avoid a user needing to re-register or turn back ON the multicast registration each time a handover is performed. Embodiments may also provide for time based turning ON or OFF of the multicast registration, for example for the multicast registration to be turned ON during working hours or turned OFF during school hours, or turned OFF automatically after a predetermined period, such as where only a particular broadcast is of interest to the user or where time based charges for broadcast services are implemented.

Alternatively, the above registration process can be incorporated into signaling used to register the communication computing device with the base station. A disadvantage of this embodiment is that updates to the base station registration signaling and base station functionality to interface with the multicast system would be required.

To send a broadcast message it is necessary for the broadcast system to first set up multicast channels for delivery of a content data stream. Where a communication network allows a data communication session, such as a GPRS communication session, to be established by an Internet server to a mobile terminal, such a connection may be established to the primary communication computing devices for each base station by the broadcast server. However in most communication networks such a connection is not allowed.

One embodiment of the invention utilizes an event alert and delivery system to cause a primary communication computing device to open a GPRS communication session to establish the multicast channel for broadcasting the data stream for reception by the primary and secondary devices. An example of a suitable event alert and delivery system is described in U.S. patent application Ser. No. 11/739,639 filed on Apr. 24, 2007 entitled “MESSAGE PUSH WITH PULL OF INFORMATION TO A COMMUNICATIONS COMPUTING DEVICE”, which claims benefit of U.S. Provisional Patent Application No. 60/810,769 filed on Jun. 2, 2006, entitled “MESSAGE PUSH WITH PULL OF INFORMATION TO A COMMUNICATIONS COMPUTING DEVICE”, both of which are incorporated by reference in their entirety.

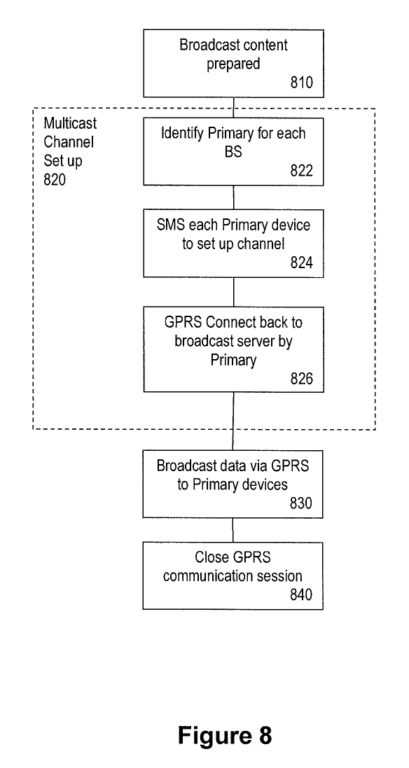

The broadcast process using an alert and delivery system is illustrated in FIG. 8 and is described in context of a system as illustrated in FIG. 4. The content unit 410 indicates to the broadcast management unit 420 when content is provided or updated 810 for broadcast. The broadcast management unit 420 uses information from the register 440 to identify the primary communication devices for each base station 822 for the data broadcast or broadcast group. For example, the broadcast may only be relevant for a particular geographical area so only the primary devices for base station in the relevant area may be identified.

The broadcast management unit 420 uses an alert and delivery service to send an alert message 824 to each identified primary communication computing device. For example in the system illustrated in FIG. 4 an alert message is sent to primary device 450. The alert message can be an SMS message which is delivered to the primary device 450. The alert message is automatically interpreted by an application running in the primary device 450 which, in turn, opens a communication session 826, such as a GPRS communication session, to either a known server, such as the broadcast management server 420 or to a destination such as a content unit server 410 identified through the alert and delivery process.

As part of the process of opening the communication session 826 by the primary communication computing device 450 to the server, a communication channel 455 is allocated to the primary device 450 by the base station 430 for the GPRS communication session. This communication channel is a one-to-one channel enabling two-way communication between the base station 430 and the primary device 450. However, this channel 455 is a multicast channel as the shared messaging units of the secondary communication computing devices 460 and 470 for base station 430 may have monitored the channel 455 allocation and enabled these devices to listen in 456 and 457 to the multicast channel 455 in a receive only mode in order to receive the broadcast content data stream as it is transmitted 830 to the primary device 450.

Once the broadcast content data stream is transmitted, the primary device 450 can close the communication session 840 which also releases the multicast channel 455. The content data stream may be transmitted a plurality of times before the communication session is closed to ensure it is received by all the secondary communication devices. The reception of the broadcast data stream for repeat transmissions may be performed as a background process in the primary communication computing device.

The secondary communications computing device 460 and 470 monitor the transmitted content data stream and displays this content on the communications computing device. When the communications computing device receives the multicast content, the communications computing device can render that content for the user of the communications computing device. The rendering of the multicast content may include, for example, displaying a video, displaying an image, generating an audible signal and/or displaying a text message.

The communications computing device can be set up to select and receive a broadcast or stream of data and the content may be stored on the communications computing device and displayed concurrently or at a pre-programmed later time. For example, the content can be displayed on the communications computing device when an event/trigger occurs or at a predetermined time.

The data stream may also contain other non-displayable data (data used by the shared messaging unit) to allow the communications computing device to select another channel of streaming data to be displayed or to schedule a time to display content from either the current channel or to select and store or display data from another channel.

In one embodiment, the communications computing device can be scheduled to join a multicast or broadcast channel at a predetermined time (based on the non-displayed data) and joins the channel at that time and displays the content. For example, the scheduled time may be the start time for retransmission of a broadcast content data stream.

The communications computing device upon registering with the network may join one or more multicast channel(s) wherein each multicast channel contains a particular type of content or content for a particular audience. Upon joining the multicast channel(s), the communications computing device receives a data stream and monitors the data stream to identify data in the stream that tells the device that it is to display the stream of content in the current stream attached or to join or attach to or monitor another channel of data and to display and format for display content for the communications computing device.

The device may also monitor a single stream that contains multiple content packages and based on predetermined settings select which content packet to process. For example, the monitored stream may contain an emergency warning message in many different languages. The language of each packet may be identified in a packet header or in a section of the packet data which can be scanned by the device. This enables the device to select a packet to process which matches the language setting on the device and load, store or display (render) the content for the user.

In one embodiment, the channel is monitored and the content contains a list of phone numbers. For example, the data stream from a multicast channel can contain data formatted to contain a specific list of communications computing devices that are to join a multicast data channel and display the content sent through the channel. This content can be stored on the communications computing device if the user is currently busy to view the content at a later time. The user may also want to store the content on the device to allow the content to be replayed many times.

In one embodiment the content is monitored and the data content contains a list of area codes. The communications computing devices can be selected based on locations like area codes, register cell station location or pre-existed lists like groups, corporations, originations, memberships or classes that is to receive, store or display the content. Alternatively, because each communications computing device has a unique number (i.e. the phone number, SIM number, or using IPV6 a unique internet address), each device can be addressed by the person that is distributing the content. This can provide local government, city or township, company, group with the ability to broadcast content and as for responses back and identify the individual that is using or has position of the communications computing device. The content data may include information enabling the user of a secondary communication computing device to connect or call back to the broadcast server, say to obtain further information, using a new channel as the secondary device is prevented from transmitting any data on the multicast channel.

The multicast system can also provide security and/or verification processing wherein a unique individual can be identified by requiring a key or secret code be entered into the communications computing device to unload or decrypt the content and allow for receipt, storage and display of the content. The system may also permit registration for voting or polling so that the system can be used for town hall meetings.

In one embodiment, the content contains a list of codes that can be used to address the content to particular users. Alternatively, the content can be formatted to contain additional data in the form of address to select individual communications computing device that are to receive and store and/or display special content for those devices. The content may also contain a list of business names codes or the streamed data can contain connection or channel information along with schedules to allow a user to select the content that they wish to receive. This can automatically be loaded into the communications computing device calendar system or displayed using a menu interface to allow for selection and scheduling of content storage and display.

The content of the system may also contain a list of special codes so that many control and schedule codes (for the different channels) can be imbedded in the data stream. The control codes may include information on how to join or register with the content transmission system, a special codex that is used to interpret the data stream for storage or display can be downloaded and/or instructions on where to go on the network, or instructions on how to download the needed plug-ins or other software programs that are need to display the content.

In one embodiment, special channels of the system or data codes in the content data stream can be used to issue special warnings to a predetermined group of people. This warning system can be used for weather related events to warn communications computing device user who are in proximity of a storm, tornado, hurricane, tsunami, volcano, other natural disaster, a terrorist action and the like. The system can also be used to warn a user of traffic or other needed information updates and alerts.

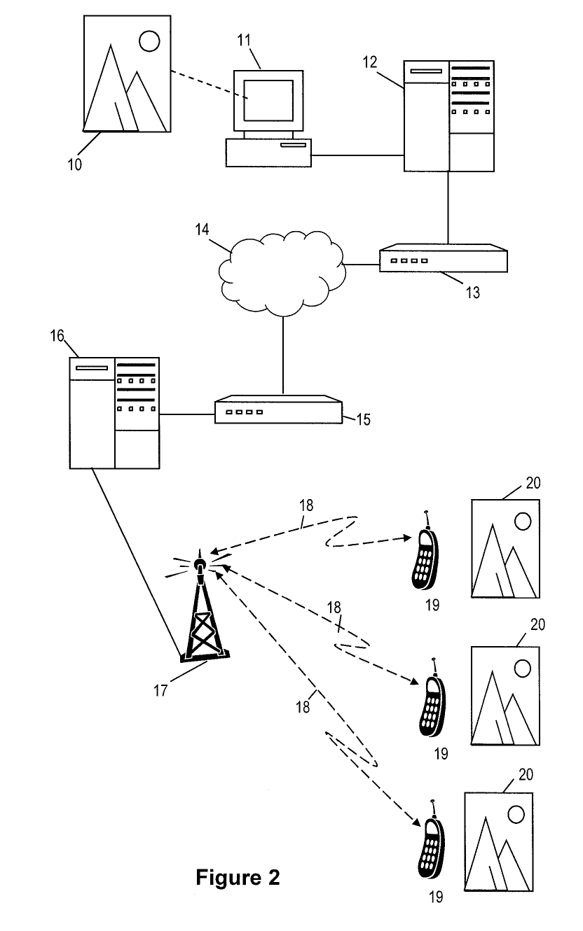

FIG. 2 illustrates the operation of the system in which an image 10 is to be sent to multiple communications computing devices 19 shown as cellular phones in this example. The communications computing devices 19 have registered, connected with or joined the multicast server 12 upon the booting or network connection process. The user loads or creates the image 10 on a computer 11 and them sends it to a multicast server 12. The multicast server 12 is connected to a network router that supports the multicast standards and sends the image across the network 14 to a router connected to a cellular network 15. The cellular network server 16 would transmit the image 10 across the wireless network 17, 18 to the communications computing devices 19 which may receive and display the transmitted image 20. Of the communication devices 19, one device is a primary device for the base station to which the multicast channel is allocated and the other devices are secondary devices adapted to only receive and display the image by listening to the multicast channel.

Mobility of devices and maintaining network connections while moving is one of the most important features of a wireless communication network. Thus some embodiments of the invention are envisaged to enable the allocation of primary devices for base stations to be changed, as necessary, due to device movements within the communication network or as devices are turned OFF or unexpectedly lose network service due to flat batteries or interference.

In one embodiment of the invention, the first communication device to register for a base station is allocated as the primary communication computing device. Each subsequent communication computing device which registers for the base station, while a primary communication computing device is allocated, is allocated as a secondary communication computing device. If a primary device shuts down or moves out of range of the servicing base station then a new primary device may be allocated.

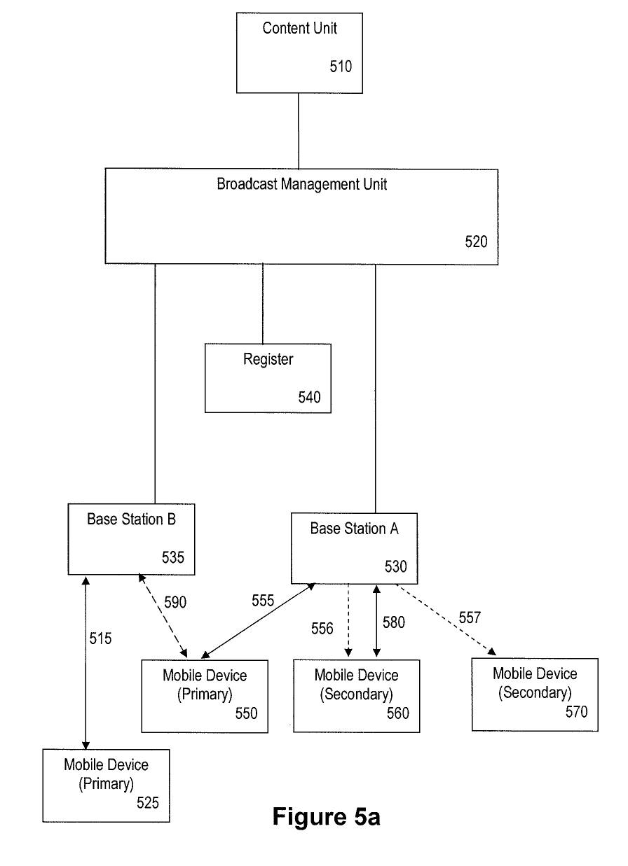

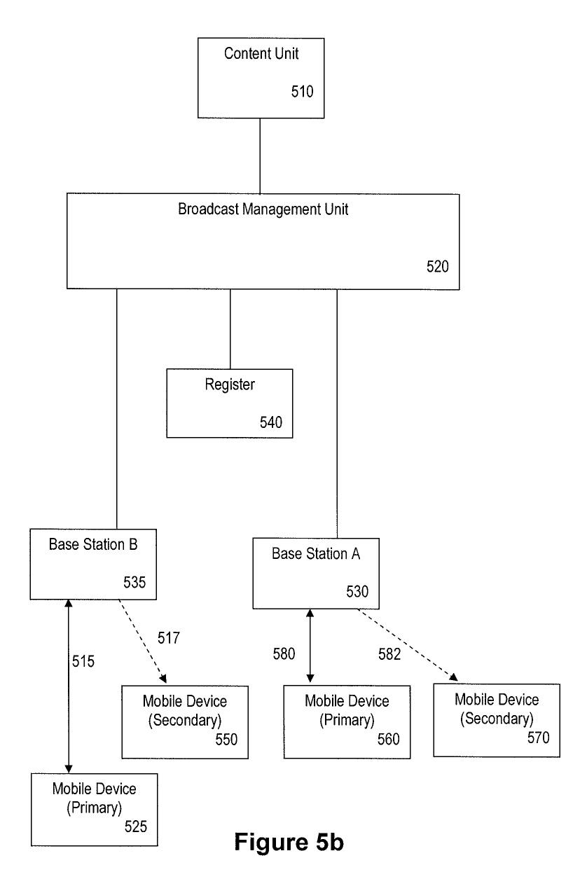

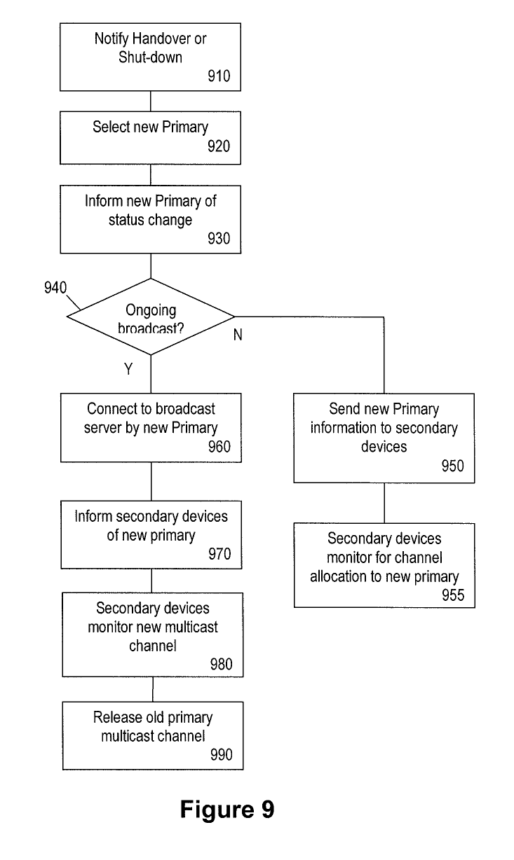

FIGS. 5a and 5b illustrate a handover of a broadcast channel. FIG. 9 is an example of a handover process in one embodiment. For example, with reference to FIGS. 5a, 5b and 9, a primary communication computing device 550 is currently being serviced by base station A 530. Any ongoing broadcast on multicast channel 555 is monitored 556 and 557 by secondary communication computing devices 560 and 570 respectively. During a handover of primary device 550 from base station 530 to base station 535 the broadcast management unit 520 is informed that a handover is required 910. The broadcast management unit 520 selects 920 a new primary communication computing device 560 from the register 540. The new primary device 560 is informed 930 of the change of status via the communication network, for example via an alert message or alternatively the handover can be included in any ongoing data broadcast which can also advise any secondary communication computing devices of the new primary identification information. If no broadcast is ongoing 940, a message, such as an SMS message can be sent to each secondary communication computing device 570 to inform them of the new primary information 950, the secondary devices 570 them monitor 955 for any broadcast channel allocated to the new primary device 560.

If any data broadcast is ongoing 940 the new primary device 560 opens a communication session 960 to the broadcast server 520 in order for a channel 580 to be allocated by base station A 530 for broadcast purposes. The secondary devices 570 can either monitor the set up of the new channel 580, and automatically switch 980 to monitoring the new channel 980, or be informed of the new channel 580 allocation and be instructed to switch 582 to monitoring the new channel 580 in the ongoing broadcast 970, then switch 582 to monitoring 980 the new channel. Once all secondary devices have been instructed to monitor the new channel 580 or monitor for channel allocation to the new primary 570, the original broadcast channel 555 can be released 990 by the old primary device 550.

During the handover signaling 590 between communication computing device 550 and base station B 535, the device 550 is registered as being service by base station B 535. The device 550 also receives information regarding the primary device 525 for base station B 535 and can also be informed of any ongoing broadcast channel 515. The device 550 becomes a secondary device for base station B 535 as a primary device 525 was already allocated. Thus, on completion of the handover the device 550 monitors 517 the ongoing broadcast channel 515.

In another embodiment a special predefined identifier is used for the primary device. This special identifier can be an additional identifier allocated to a primary device, such as an additional phone number or address such that the primary device responds to a channel allocation for the special predefined identifier as well as its own identifier. Alternatively, the special predefined identifier may represent an imaginary or virtual primary device which may be implemented in the base station software, for example a reserved identifier used for testing and diagnostics may be utilized, such that the base station allocates and sets up a channel to itself for its software implement virtual communication computing device, and transmits data on this channel to its own virtual communication computing device which, in turn, can be monitored by the secondary devices as the virtual device is allocated as the primary device for the cell. An advantage of the virtual primary device is that, unlike a real primary device, the primary device does not roam or handover from the base station. In an embodiment the same special predefined identifier is used for primary devices across all base stations. This has an advantage of when a device switches from one base station to another while roaming the same primary device identifier can be used.

A shut down process for a primary device can be implemented to follow a similar process to handover, to allocate another primary device and provided the new primary information to the secondary devices.

In case a primary device shuts down or disconnects from the base station unexpectedly or for some other reason a handover is not completed, the allocation of a new primary device may fail. The broadcast management system can be implemented to periodically poll or query either the base station or the primary device to determine whether the device is still in service with the base station as registered. If it is determined that a primary device has ceased to be serviced by a base station a new primary device can be allocated and the secondary devices informed as described above.

A number of different schemes can be used for selection of a new primary device. In one embodiment of the invention, a secondary communication computing device which has been in service with the base station for the longest period of time is allocated as a new primary device for a base station. For this scheme the assumption is that the secondary device that has been connected to the base station for the longest time is not moving through the service area and may remain a primary device before a handover is required longer than a device selected randomly or newly handed over into the base station service area. Alternatively, historical information can be used to determine whether a device is commonly registered for a base station, for example if the user's home is in the base station area, and this device may be selected as a primary device. Users of communication computing devices may also be able to nominate, for example by setting a parameter value or other instruction, not to be allocated as a primary device or particular properties may be used to disallow devices being allocated as primary devices. For example, if a global roaming setting may bar a device from being selected a primary device due to additional costs incurred for the broadcast.

To encourage users not to bar their device from being allocated as a primary device, a scheme may be implemented in conjunction with mobile communication network operators to provide the broadcast data services free to the primary device user. For example, the costs for a multicast channel allocation may be billed to the broadcast service operator by the communication network rather than the device user.

In some embodiments of the invention, more than one communication computing device is allocated as a primary device for a base station, in order to provide more than one possible multicast channel. Each multicast channel may be used to broadcast the same broadcast data and each secondary device can determine which multicast channel to receive. For example this selection may be based on reception quality, for example signal strength or interference to noise ratio of the multicast signals.

Alternatively an embodiment may be implemented where each base station is allocated a “main” primary and one or more “backup” primary devices each having a different addressable number to the main primary device. Each secondary device is provided with information for both main and backup primary devices and watches for a channel allocation for any primary devices but only monitors the channel for the backup primary if a channel is not allocated to the main primary or the data on this channel cannot be received, for example the main primary goes off-line or hands off to another base station.

Alternatively embodiments may be adapted to receive more than one multicast channel simultaneously and if the same data is broadcast on all channels combine the received data packets for error correcting and data reliability purposes. In such embodiments, as a primary device goes off line or hands over to another base station, further primary devices or main primary and backup primary devices are allocated and the secondary devices informed of the updated configuration as described above.

In another embodiment of the invention, a primary communication computing device can be provided with functionality to control the transmission power or request a higher power transmission for broadcast data on the multicast channel. This minimizes the risk of a broadcast signal having insufficient power to be monitored by a secondary communication computing device.

Alternatively a base station can be provided with functionality to determine when a channel is allocated for broadcast purposes and control the signal transmission power to ensure the signal is receivable by all communication computing devices of that base station. For example based on power control signals of all the devices of that base station and transmitting at the highest required power. Such as scheme may be of advantage in a emergency message broadcast system to ensure all devices are capable of receiving the broadcast message.

Those of ordinary skill would further appreciate that the various illustrative logical blocks, modules, and algorithm steps described in connection with the examples disclosed herein may be implemented as electronic hardware, firmware, computer software, middleware, microcode, or combinations thereof. For example, a “module” in such a system may be implemented in a hardware circuit, software, firmware, and/or any combination thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

What is claimed is:

1. A method of broadcasting messages to communication devices in a mobile communication network, the method comprising:
registering at least one communication device serviced by a base station, the at least one communication device configured to receive broadcast messages;
allocating at least one registered communication device as a primary communication device for the base station and the remaining registered communication devices as secondary communication devices; and
providing information identifying the primary communication device to each secondary communication device.

2. The method as claimed in claim 1, wherein providing the information identifying the primary communication device comprises enabling the secondary communication devices to monitor for a channel to be allocated to the primary communication device for broadcast purposes.

3. The method as claimed in claim 2, further comprising receiving broadcast data transmitted over the channel allocated to the primary communication device.

4. The method as claimed in claim 1, further comprising querying a user of one of the communication devices as to whether to receive and display broadcast data.

5. The method as claimed in claim 2, further comprising monitoring for the channel to be allocated to the primary communication device by monitoring channel allocation signals on a control channel to determine when a channel is allocated to the primary communication device

6. The method as claimed in claim 1, further comprising determining whether data being transmitted to the primary communication device comprises broadcast data based on information from the transmitted data, such that the one or more secondary communication devices only receive broadcast data.

7. The method as claimed in claim 1, further comprising encrypting broadcast data using a broadcast encryption scheme configured to be decrypted by the primary and secondary communication devices.

8. The method as claimed in claim 7, wherein the broadcast encryption scheme uses a decryption key available to the primary and secondary communication devices.

9. The method as claimed in claim 8, wherein the decryption key comprises a public key of the primary communication device.

10. The method as claimed in claim 7, wherein the broadcast encryption scheme is different from an encryption scheme used for non-broadcast transmission to the primary communication device.

11. The method as claimed in claim 10, further comprising using the encryption scheme to determine whether data comprises broadcast data.

12. The method as claimed in claim 1, further comprising transmitting broadcast data is to the primary communication device using GPRS protocols.

13. The method as claimed in claim 1, further comprising:
allocating a communication device as a further primary communication device for the base station; and
providing information identifying the further primary communication device to each secondary communication device to enable the secondary communication devices to determine that a channel is allocated to more than one primary communication device for broadcast purposes, and choose which channel to receive broadcast data over.

14. A messaging unit for a communication device comprising:
a memory module configured to store information identifying a primary communication device for a base station servicing the communication device; and
a monitoring module configured to monitor channel allocations transmitted by the base station to determine that a channel is allocated to the primary communication device, based at least in part on said stored identifying information.

15. The messaging unit as claimed in claim 14, further comprising a receiver module configured to receive broadcast data transmitted over the channel determined to be allocated to the primary communication device.

16. The messaging unit as claimed in claim 14, further comprising a user interface module configured to query a user of the communication device whether to receive and display or store broadcast data.

17. The messaging unit as claimed in claim 14, further comprising a registration module configured to register with the base station when the communication device is allocated as the primary communication device for the base station for broadcast purposes.

18. The messaging unit as claimed in claim 17, further comprising an encryption module configured to instruct the base station in relation to an encryption scheme to use for transmission of broadcast data.

19. The messaging unit as claimed in claim 14, implemented as a software application.

20. A communication device comprising the messaging unit as claimed in claim 14.

21. A system for enabling messages to be broadcast to communications devices in use in a mobile communication network the system comprising:
a network interface module configured to communicate with a content unit configured to provide content for broadcast; and
a broadcast management unit configured to connect to a communication network and register identification information for communication devices serviced by one or more base stations, the communication devices configured to receive broadcast messages, and allocate at least one communication device for each of the base stations as a primary communication device for broadcast purposes and allocate other communication devices as secondary communication devices, the broadcast management unit being further configured to deliver the content provided by the content unit to one or more of the primary communication devices using a communication channel allocated by the communication network, whereby the secondary communication devices monitor the channel allocated to the primary communication device.

22. The system as claimed in claim 21, further comprising one or more communication devices wherein each communication device includes a shared messaging unit to be configured to monitor the channel allocated to the primary communication device.

23. The system as claimed in claim 21, the broadcast management unit being further configured to download a software application to a communication device to configure the communication device to monitor the channel allocated to the primary communication device.

24. A method of receiving broadcast messages in a mobile communication network, the method comprising:
registering a communication device to receive broadcast messages;
receiving information allocating the registered communication device as a primary communication device for a base station or a secondary communication device;
receiving information identifying the primary communication device for the base station; and
monitoring for a channel to be allocated to the primary communication device for broadcast purposes.

25. The method as claimed in claim 24, further comprising receiving broadcast data over the channel allocated to the primary communication device.

26. The method as claimed in claim 24, further comprising querying a user of the communication device as to whether to receive and display broadcast data.

27. The method as claimed in claim 24, wherein monitoring for the channel to be allocated to the allocated to the primary communication device further comprises monitoring a control channel.

28. The method as claimed in claim 24, further comprising determining whether data transmitted to the primary communication device over the allocated channel comprises broadcast data based on information from the transmitted data, and discarding any data determined to be non-broadcast data.

29. The method as claimed in claim 25, wherein the broadcast data is encrypted using a broadcast encryption scheme configured to be decrypted by the registered communication device allocated as the primary or the secondary communication device.

30. The method as claimed in claim 29, wherein the broadcast encryption scheme uses a decryption key registered commonly in each communication device for the base station.

31. The method as claimed in claim 30, wherein the decryption key comprises a public key of the primary communication device.

32. The method as claimed in claim 29, wherein the broadcast encryption scheme is different from an encryption scheme used for non-broadcast transmission to the primary communication device.

33. The method as claimed in claim 32, further comprising determining whether data transmitted over the allocated channel comprises broadcast data based on the encryption scheme.

34. The method as claimed in claim 25, wherein receiving the broadcast data comprises receiving the broadcast data transmitted to the primary communication device using GPRS protocols.

35. The method as claimed in claim 24, wherein two or more communication devices are registered as primary communication devices for the base station, the method further comprising receiving information on the monitored channel identifying two channels allocated to the two primary communication devices as multicast channels and choosing which of the two allocated channels to receive broadcast data over.

36. A computer readable medium comprising programming instructions that upon executing cause a machine to:
register at least one communication device serviced by a base station, the at least one communication device configured to receive broadcast messages;
allocate at least one registered communication device as a primary communication device for the base station and allocate the remaining registered communication devices as secondary communication devices; and
provide information identifying the primary communication device to each secondary communication device.

37. The computer readable medium of claim 36, wherein the information identifying the primary communication device enables the secondary communication devices to monitor for a channel to be allocated to the primary communication device for broadcast purposes.

38. A computer readable medium comprising programming instructions that upon executing cause a machine to:
register a communication device to receive broadcast messages;
receive information allocating the registered communication device as a primary communication device for a base station or a secondary communication device;
receive information identifying the primary communication device for the base station; and
monitor for a channel to be allocated to the primary communication device for broadcast purposes.
